(19) United States
(12) Patent Application Publication
(10) Pub. No.: US 2022/0109312 A1
(43) Pub. Date: Apr. 7, 2022

(54) SYSTEM FOR CHARGING ELECTRONIC DEVICES

(71) Applicants: James Brenza, Delaware, OH (US); Rich Dammkoehler, Gibson City, IL (US); Guy Schroeder, Spencer, OH (US)

(72) Inventors: James Brenza, Delaware, OH (US); Rich Dammkoehler, Gibson City, IL (US); Guy Schroeder, Spencer, OH (US)

(21) Appl. No.: 17/064,740

(22) Filed: Oct. 7, 2020

(51) Int. Cl. H02J 7/00; H02J 7/35

(52) U.S. Cl. CPC H02J 7/0045; H02J 7/00032; H02J 7/35

(57) ABSTRACT

A system for charging electronic devices without physically disturbing them. The system includes at least one charging hat and at least one base unit. Each charging hat includes a power cell, a control circuit, and a first electric mating feature housed within an enclosure. Preferably, each charging hat may also be provided with a photovoltaic cell. The base unit includes a second electric mating feature configured to mate with the first electric mating feature and an electronic device. By attaching the charging hat to a potentially stationary base unit, the first electric mating feature may mate with the second electric mating feature, establishing an electric connection therebetween, which thereby enables the power cell to supply power to the electronic device without physically disturbing it. Also disclosed are charging bars for charging multiple charging hats.

### CROSS-REFERENCE TO RELATED APPLICATIONS

This application is a nonprovisional patent application that makes no claim of priority.

### TECHNICAL FIELD

The application relates to systems for charging electronic devices and, more particularly, to systems that include detachable, self-contained power sources that contain a photovoltaic cell.

### BACKGROUND

Wireless, battery operated electronic devices often require battery replacement after a period of time. Doing so typically requires moving or maneuvering the electronic device to access the battery compartment. Additionally, removing the batteries will interrupt the electrical current necessary for continuous operation. However, depending on the electronic device, this may be undesirable or even detrimental to the operation of the electronic device if the electronic device is meant to be stationary. For example, the electronic device may be a vibration sensing device that requires continuous, undisturbed contact with a surface being monitored. Moving such a device may result in breaking contact with the surface. In another example, the electronic device may include a sensor that is continuously monitoring one or more environmental conditions and will suffer a disruption in reading activity if physically disturbed. As yet another example, the electronic device may include delicate or fragile internal components, which may be disrupted if the device is moved. For at least these reasons, it is often impractical to periodically change the batteries in these devices even though doing so may become necessary.

### SUMMARY OF THE INVENTION

Disclosed herein are systems for charging electronic devices that include at least one charging hat and at least one base unit.

In one embodiment, the system includes a charging hat that includes a control circuit electrically connected to a power cell and a first electric mating feature. The charging hat further includes an enclosure that defines an open space. The control circuit, the power cell, and the first electric mating feature are housed within the enclosure. The base unit includes an electronic device and a second electric mating feature that is configured to mate with the first electric mating feature, wherein the base unit is configured to be inserted into the open space of the charging hat. The charging hat is configured to transmit electricity to the electronic device when the first electric mating feature is mated with the second electric mating feature.

In another embodiment, the system includes a plurality of charging hats. Each charging hat includes a control circuit electrically connected to a power cell and a first electric mating feature. Each charging hat further includes an enclosure that defines an open space. The control circuit, the power cell, and the first electric mating feature are housed within the enclosure. The system further includes a plurality of base units. Each base unit includes an electronic device and a second electric mating feature that is electrically connected to the electronic device. The second electric mating feature is configured to mate with the first electric mating feature, and each base unit is configured to be inserted into the open space of the charging hat. Each charging hat is configured to transmit electricity to the electronic device of a base unit when the first electric mating feature of the charging hat is mated to the second electric mating feature of the base unit. Each charging hat further includes a first standardized attachment feature and each base unit further includes a second standardized attachment feature, wherein each first standardized attachment feature is configured to correspond with each second standardized attachment feature.

In yet another embodiment, the system includes a plurality of charging hats. Each charging hat includes a control circuit electrically connected to a power cell and a first electric mating feature. Each charging hat further includes an enclosure that defines an open space. The control circuit, the power cell, and the first electric mating feature are housed within the enclosure. The system further includes a plurality of base units. Each base unit includes an electronic device and a second electric mating feature that is electrically connected to the electronic device. The second electric mating feature is configured to mate with the first electric mating feature, and each base unit is configured to be inserted into the open space of the charging hat. The system further includes a charging bar that includes a charging circuit and plurality of charging base connectors. Each charging base connecter includes a third electric mating feature and is configured to be inserted into the open space of a charging hat. The charging circuit is configured to transmit electricity to each third electric mating feature. Each charging hat is configured to transmit electricity to the electronic device of a base unit when the first electric mating feature of the charging hat is mated to the second electric mating feature of the base unit. The charging bar is configured to transmit electricity to a charging hat when the first electric mating feature of the charging hat is mated to the third electric mating feature of a charging base connector.

Other examples of the disclosed system for charging electronic devices will become apparent from the following detailed description, the accompanying drawings and the appended claims.

### BRIEF DESCRIPTION OF THE DRAWINGS

FIG. 1 is a top perspective view of a first embodiment of a system for charging electronic devices;

FIG. 2 is an exploded top perspective view of a charging hat of the system of FIG. 1;

FIG. 3 is an exploded rear perspective view of the system of FIG. 1;

FIG. 4 is an exploded top perspective view of the system of FIG. 1;

FIG. 5 is an exploded top perspective view of a base unit of the system of FIG. 1;

FIG. 6 is an exploded top perspective view of a second embodiment of the system for charging electronic devices;

FIG. 7 is an exploded rear perspective view of the system of FIG. 6;

FIG. 8 is an exploded top perspective view of a base unit of the system of FIG. 6;

FIG. 9 is an exploded top perspective view of a first charging bar with three charging hats;

FIG. 10 is a top perspective view of the first charging bar of FIG. 9 with a second charging bar; and

FIG. 11 is a rear perspective view of the charging bar of FIG. 9.

### DETAILED DESCRIPTION

The following detailed description refers to the accompanying drawings, which illustrate specific examples described by the disclosure. Other examples having different structures and operations do not depart from the scope of the present disclosure. Like reference numerals may refer to the same feature, element, or component in the different drawings.

Illustrative, non-exhaustive examples, which may be, but are not necessarily claimed, of the subject matter according the present disclosure are provided below. Reference herein to “example” means that one or more feature, structure, element, component, characteristic and/or operational step described in connection with the example is included in at least one embodiment and/or implementation of the subject matter according to the present disclosure. Thus, the phrase “an example” and similar language throughout the present disclosure may, but do not necessarily, refer to the same example. Further, the subject matter characterizing any one example may, but does not necessarily, include the subject matter characterizing any other example.

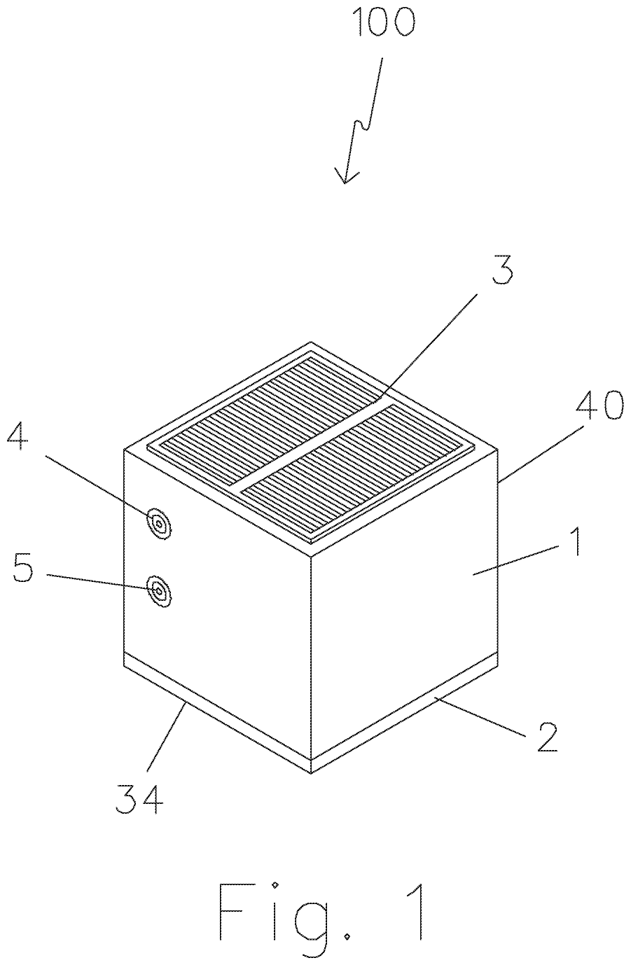

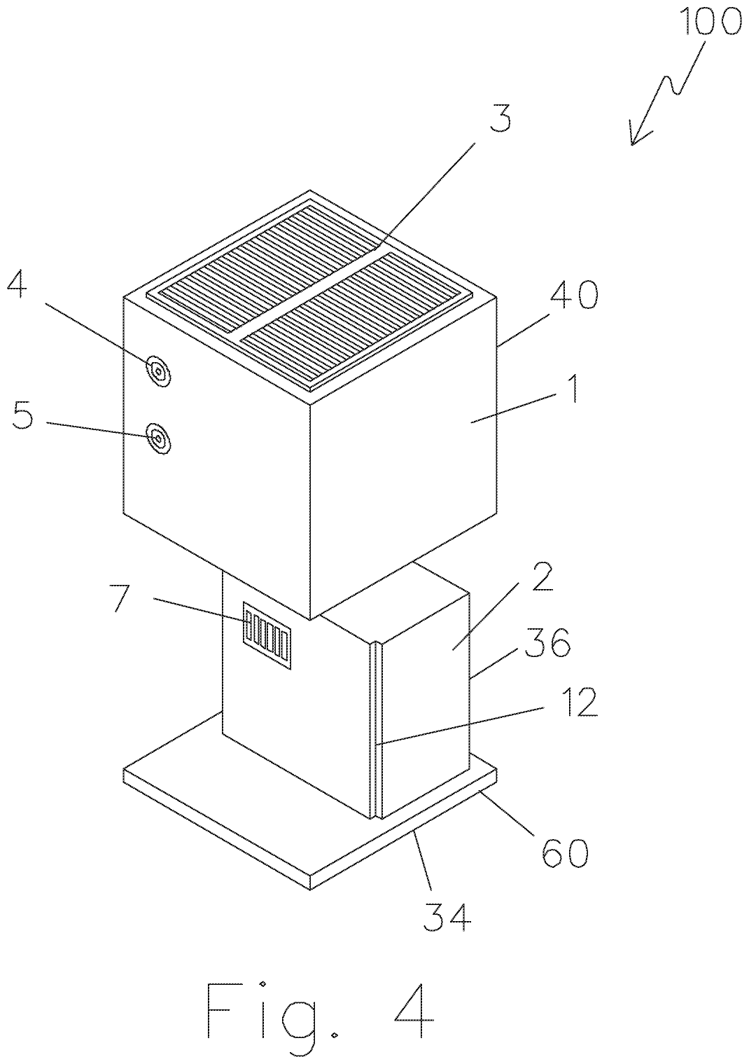

Referring to FIGS. 1-5, the present disclosure provides an embodiment of a system 100 for charging electronic devices (herein, “the system”) that is designed to enable a user to quickly swap out a power source for an electronic device with little to no disruptions to the electronic device. More specifically, the process of removing and replacing the power source can be performed with little to no physical movement of the electronic device, thereby allowing the electronic device to remain still, in-place, and in operation. While the system 100 is not limited to such applications, it is generally contemplated that the system 100 may be best applied to electronic devices that were meant to be stationary or at least quasi-stationary, especially while operating.

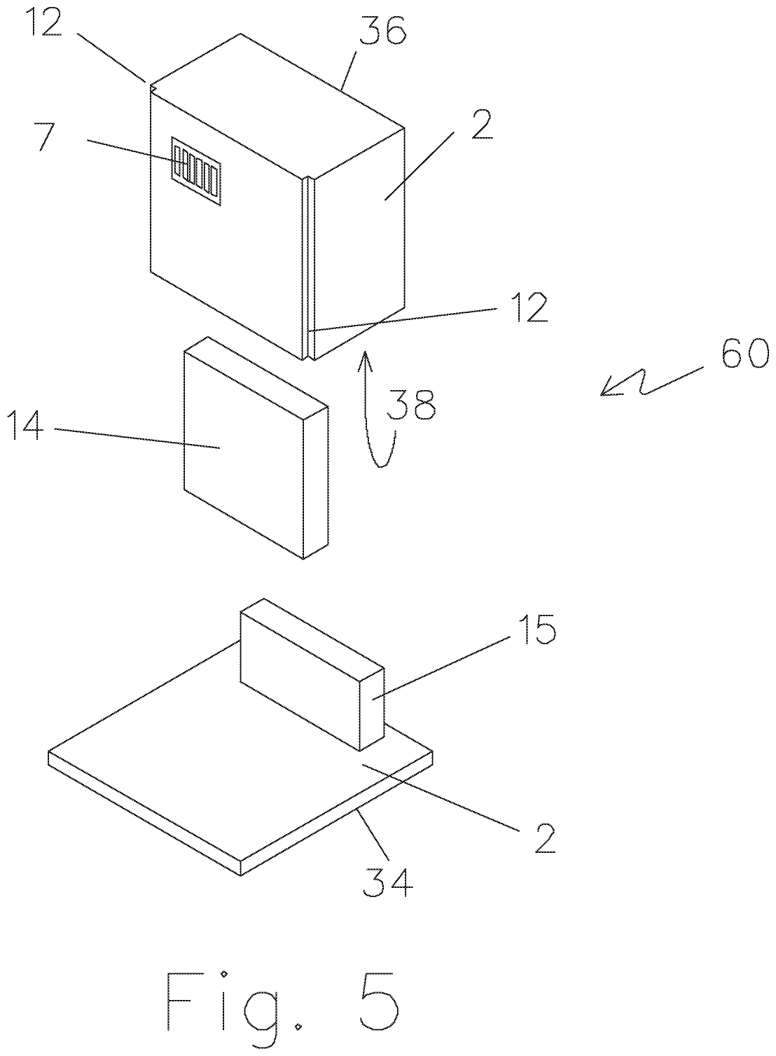

In its simplest embodiment, the system 100 includes a charging hat 40 and a base unit 60 that either includes or is connected to an electronic device 15 (shown as a part of base unit in FIG. 5). The charging hat 40 may be received over the base unit 60 and an electric connection may be established therebetween. In doing so, the charging hat 40 may supply the electronic device 15 with power (i.e., electricity) until such time that the electric voltage potential of the charging hat 40 is depleted. At which point, the charging hat 40 may be detached from the base unit 60, recharged elsewhere, and then reattached as needed.

In other embodiments, a plurality of charging hats 40 may be provided such that the base unit 60 may be recharged simply by detaching a spent charging hat and attaching a fresh (i.e., charged) charging hat. The spent charging hat may then be recharged as the fresh charging hat supplies power to the electronic device 15. Moreover, additional base units 60 may also be included, preferably with standardized attachment features, such that a charging hat 40 may be used to charge a variety of different base units 60. A combination of multiple charging hats 40 and multiple base units 60 may collectively comprise a system of charging electronic devices 100.

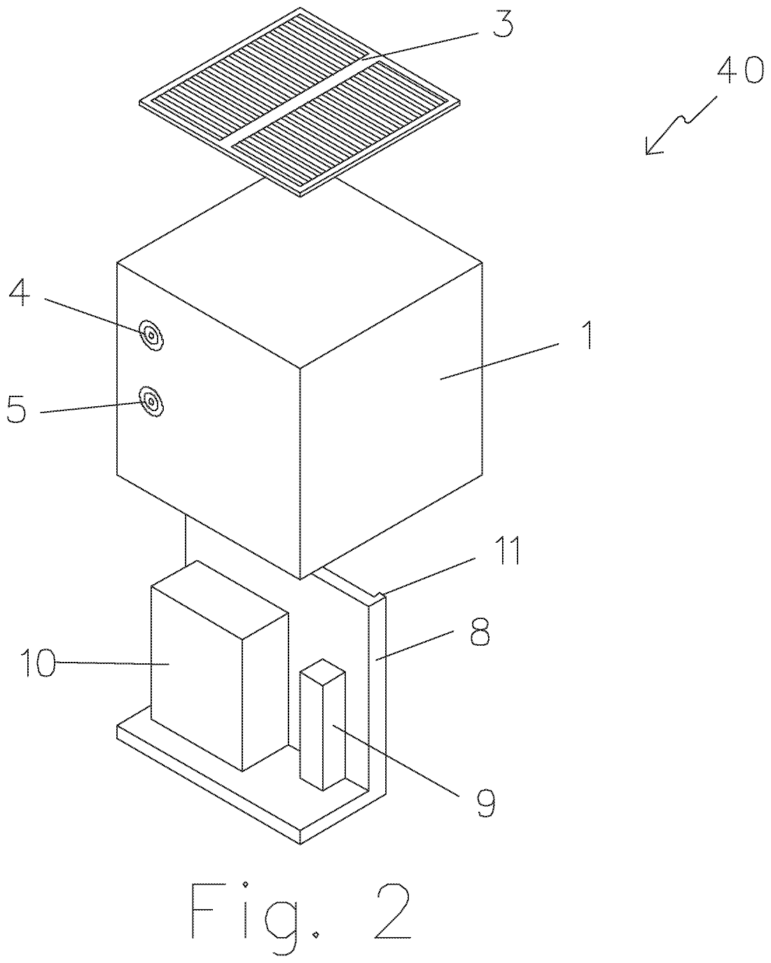

Referring to FIG. 2, the charging hat includes a power cell 9 and a control circuit 10. The control circuit 10 may include circuitry for power management (e.g., for regulating the current into and out of the power cell 9) and/or a universal adapter module for monitoring and controlling one or more parts of the system 100. The power cell 9 may include any device capable of maintaining an electric voltage potential, such as batteries, capacitors, combinations thereof, and/or the like. Since the power cell 9 is not constrained to the physical dimensions of a battery compartment, and since the charging hat 40 may be fabricated in larger sizes if desired, it is contemplated that the power cells 9 of the present disclosure may be relatively high-capacity. In one example, and subject to implementation requirements, the power cell 9 may include power capacity of about 200 milliamp hours to about 40,000 milliamp hours, and more favorably 1,000 to 10,000, and more favorably still 2,000 to 4,000. In another example, the voltage of the power cell 9 may range from about 1 volt to about 50 volts, or more favorably from about 1 volt to about 15 volts, or even more favorably from about 1 volt to about 5 volts. In yet another example, the power cell 9 and the control circuit may be configured to output a current ranging from about 1 microamps to about 10 amps, or more favorably about 1 microamps to about 2 amps, or even more favorably about 1 microamps to about 500 milliamps. The power output and capacity of any given embodiment of the charging hats 40 may be varied as needed to accommodate the system requirements of the electronic device it will be powering.

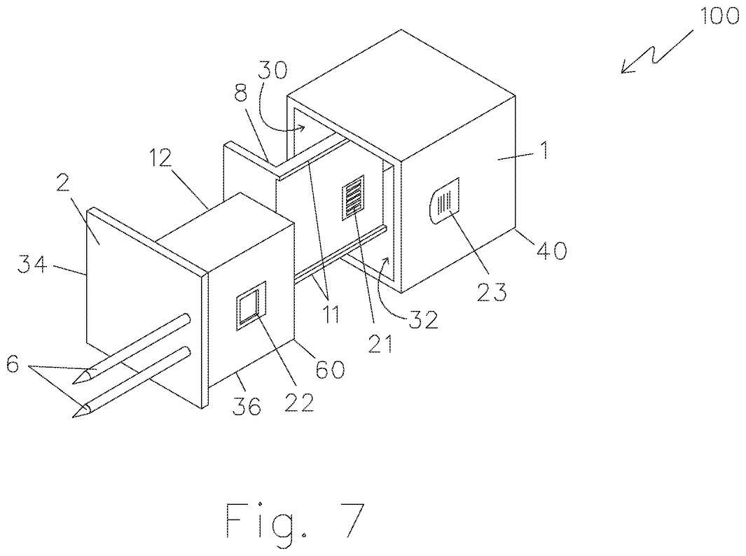

The charging hat 40 may further include a bracket 8 and an enclosure 1. The power cell 9 and the control circuit 10 may be attached to the bracket 8, which may then be housed within the enclosure 1. As shown, the enclosure 1 may be generally cube-shaped, having one open side (FIG. 7), and the bracket 8 may be L-shaped. The bracket 8 may be received within the enclosure 1 and disposed along one of the interior sides of the enclosure 1. This configuration provides for a closed space 30 and an open space 32 within the charging hat 40, with the power cell 9 and the control circuit 10 located within the closed space 30. In preferred embodiments, the bracket 8 and the enclosure 1 may be sized such that the closed space 30 may be a confined and hermetically sealed environment, thereby offering a greater degree of protection to the power cell 9 and the control circuit 10 (e.g., from water and debris). However, as those skilled in the art will appreciate, this is just one non-limiting example as other shapes and configurations may also be employed without departing from the scope of the present disclosure.

Ideally, the charging hat 40 may be provided with one or more recharging features connected to the power cell and configured to recharge it. In the example shown, two recharging features are provided—an array of photovoltaic cells 3 on the top side of the charging hat enclosure 1 and a power supply port 4 located on the front. The photovoltaic cells 3 may be connected to the power cell 9 and configured to recharge it using energy gathered from light. Examples of photovoltaic cells that may be suitable for such a purpose may include, without limitation, monocrystalline solar panels, polycrystalline solar panels, and thin-film solar panels. The power supply port 4 may be connected/coupled to an appropriate external power supply by way of an appropriate cable and used to supply power to the power cell 9, which may be particularly desirable when the photovoltaic cells 3 are not a viable source for recharging (e.g., due to darkness, inclement weather, etc.). Further, in one or more embodiments, the power supply port 4, the photovoltaic cell 3, and the control circuit 10 may be configured, individually or collectively, to provide for pass-through charging of the base unit 60 and/or the electronic device 15.

The charging hat 40 may also be provided with a data port 5 that may be in electronic communication with the power cell 9 and/or the control circuit 10. This data port 5 may be utilized for data transmission and diagnostics relating to the charging rate and power capacity of the internal power supply, among other things. As shown, the data port 5 may be located on the front side of the charging hat enclosure 1 adjacent to the power supply port 4. It is contemplated that the charging hat 40 and/or the base unit 60 may be connected in electronic communication to a computer that would enable a user to interface with and/or control the charging hat 40 and/or the base unit 60. This connection may be established by any suitable method such as, but not limited to, an appropriate cable connecting the data port 5 to a computer, a wireless transceiver (e.g., configured for Bluetooth, WIFI, etc.) coupled to the data port 5, and/or the like.

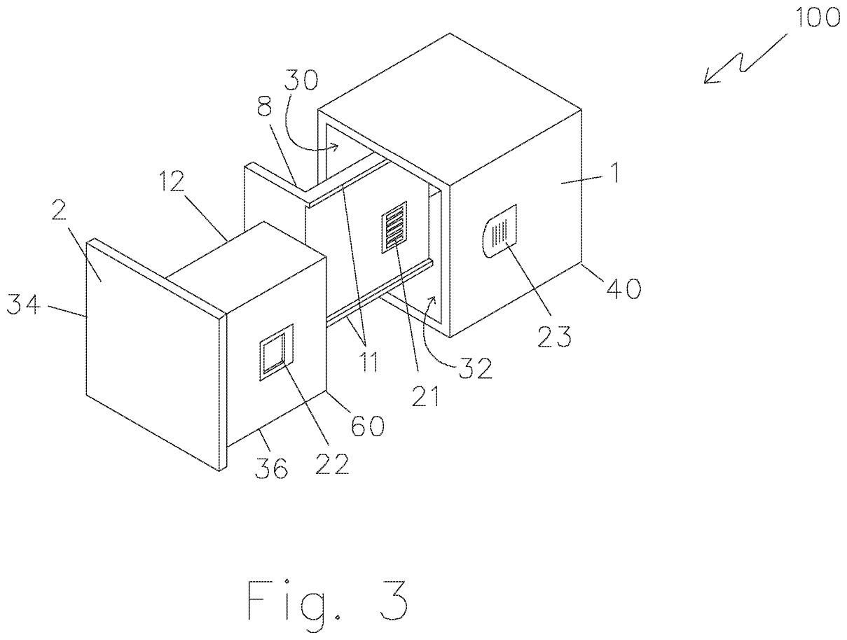

Referring to FIG. 3, the charging hat 40 also includes an electric mating feature 21 that enables the charging hat 40 to electrically mate with the base unit 60. More specifically, the base unit 60 may be provided with a corresponding electric mating feature 7 that may be configured to mate with the electric mating feature 21 on the charging hat 40. Once mated, an electric connection may be established though these electric mating features 7, 21 that enables the charging hat 40 to supply power to the electronic device 15 within or connected to the base unit 60. As shown in FIGS. 3-5, these electric mating features 7, 21 may include a series of corresponding pins located on, and extending through, the bracket 8 of the charging hat 40, and on the body 2 of the base unit 60. In other embodiments, however, different components and methods for establishing an electric connection may be employed without departing from the scope of the present disclosure.

The body 2 of the base unit 60 may include a bottom portion 34 and an enclosure 36. The electric mating feature 7 of the base unit 60 may be located on the enclosure 36 and disposed such that the electric mating feature 7 aligns with the electric mating feature 21 on the charging hat 40 when the base unit enclosure 36 is inserted into the open space 32 of the charging hat 40. The bottom portion 34 may be generally planar, square in shape, and similar in size (e.g., length and width) to the sides of the charging hat enclosure 1. This design provides for a cube-shaped configuration when the charging hat 40 is received over the base unit 60. Of course, the enclosure 36 of the base unit 60 may be generally rectangular in shape (in cross-section) and sized as appropriate to fit within the open space 36 of the charging hat 40.

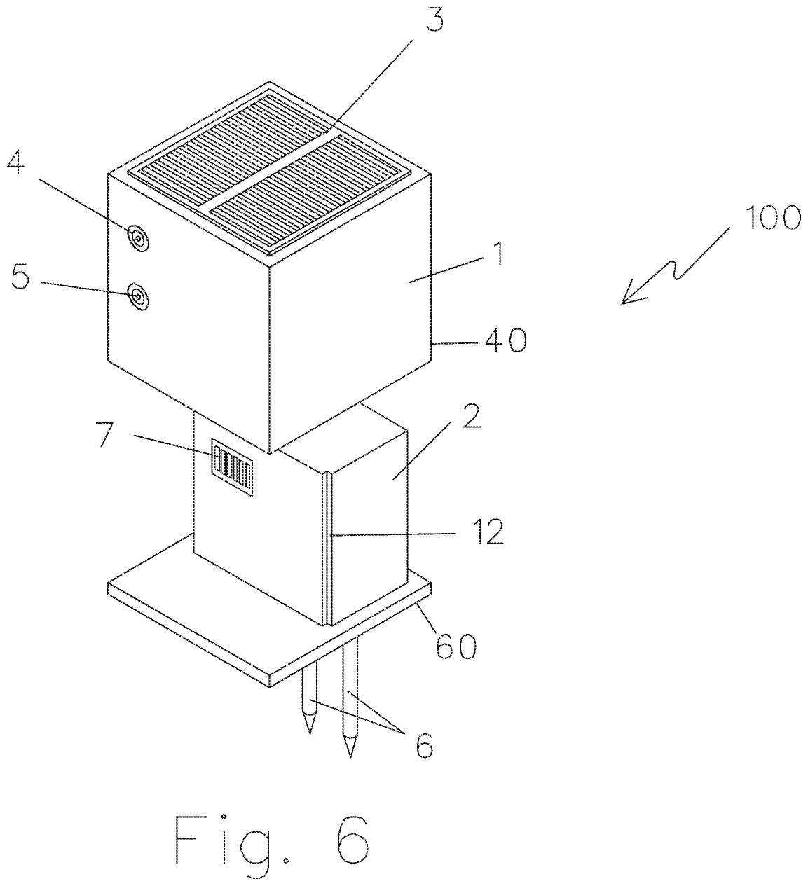

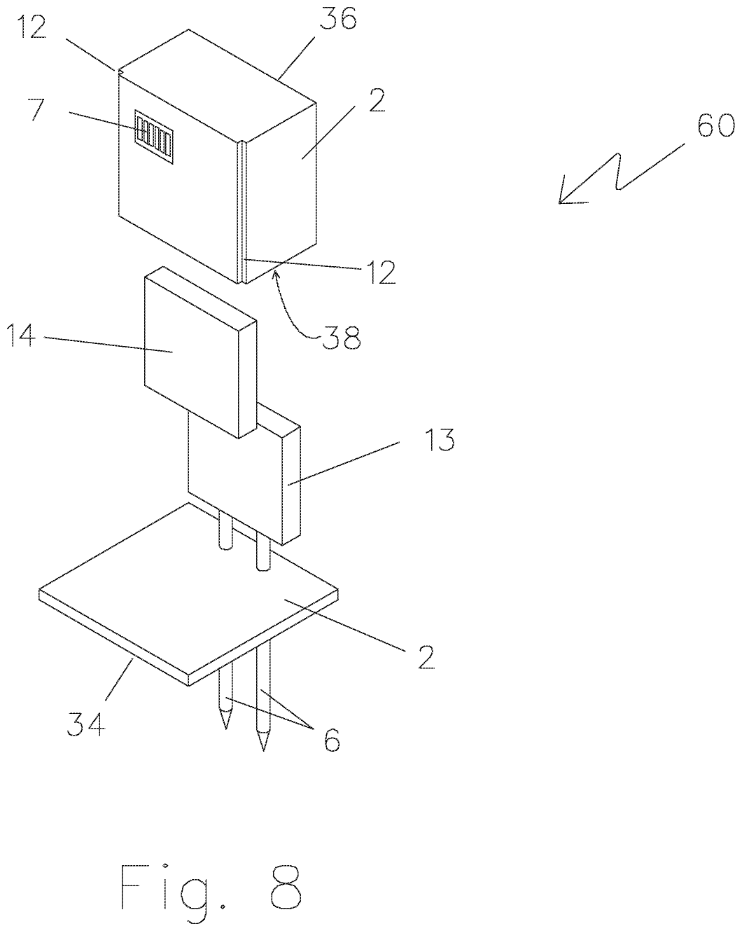

The bottom portion 34 and the enclosure 36 of the base unit 60 define a closed space 38 therebetween. As those skilled in the art will appreciate, this configuration also provides for a confined, hermetically sealed environment. Positioned within this closed space 38 may be an electronic device 15 (i.e., the circuitry for an electronic device), or a means of connecting to an external electronic device (e.g., wires, cables, ports, etc.). While ostensibly any suitable electronic device may be included, it is generally contemplated that given the size constraints of the base unit 60 and the charging hat 40, that small sensors (e.g., environmental sensors for vibration, temperature, moisture, air pressure, pH, light, electrical conductivity, etc.), micro-controlled devices (e.g., cameras, flow meters, solenoids, actuators, etc.), and the like might be the most suitable. For example, the embodiment shown in FIGS. 6-8 makes use of a small soil sensor integrated into the body 2 of the base unit 60. The soil sensor includes sensor electronics 13 and sensor pins 6 that extend through the bottom portion 34 of the body 2. This base unit 60 may be inserted into soil to continuously monitor soil conditions (e.g., moisture, pH, etc.). An example of a suitable soil sensor that may utilized as such may include, without limitation, any sensor capable of monitoring soil moisture, electrical conductivity, temperature, pH, fertilizer concentration, or chemical runoff. Of course, the size of the base unit 60 and the charging hat 40 are not meant to be limiting features as either may be sized up or down to accommodate various other electronic devices.

A secondary power cell 14 (and associated circuitry) may also be provided within the closed space 38 of the base unit 60. This secondary power cell 14 may serve as a temporary power supply to the electronic device 15 while the charging hat 40 is either being recharged or swapped out for a fresh charging hat. Accordingly, it is contemplated that the secondary power cell 14 of the base unit 60 need not be as large in power capacity as the power cell in the charging hat 40. For example, an about 200 milliamp hours to about 800 milliamp hours power cell may be suitable. In preferred embodiments, this secondary power cell 14 may also be recharged by the photovoltaic cells 3, if provided, or through the power supply port 4 like the power cell 9 in the charging hat 40. Of course, this secondary power cell 14 should also be electrically connected to the electronic device 15 and to the electric mating feature 7 of the base unit 60.

In one or more embodiments, the charging hat 40 and the base unit 60 may be provided with attachment features that facilitate the secure attachment of the charging hat 40 onto the base unit 60. For example, key rails 11 may be provided on the bracket 8 of the charging hat 40 that correspond with alignment notches 12 on the enclosure 36 of the base unit 60. These attachment features ensure that the base unit 60 will be properly inserted into the open space 32 of the charging hat 40 and that the two electric mating features 7, 21 will be kept in engagement. As another example, a latch 22 may be provided on the back side of the enclosure 36 of the base unit 60 that corresponds with a release button 23 of the back side of the enclosure 1 of the charging hat 40 (FIG. 7). These attachment features may ensure that the charging hat 40 is securely attached onto the base unit 60, and will not slide off unintentionally. As those skilled in the art will appreciate, various other attachment features (e.g., beveled edges for proper alignment, threads for twist-to-lock features, adhesives, mechanical fasteners, magnets, etc.) may also be employed without departing from the scope of the present disclosure.

In embodiments where an electronic device 15 is provided within the base unit 60, the system 100 may enable the charging hat 40 to be detached from the base unit 60 and then reattached without significantly disrupting the electronic device 15, if at all. Since the charging hat 40 can simply be lifted off the top of base unit 60, there is no need to physically move the base unit 60 to recharge it, thereby avoiding any potential disruptions to the operation of the electronic device 15 located therein.

It is generally contemplated that for embodiments of the system 100 that include multiple charging hats 40 and multiple base units 60, it may be preferred that the sizes and shapes of the charging hats 40 (or at least the open spaces 32 within the charging hats 40) and the base units 60 (or at least the enclosures 36 of the base units 60) be standardized across all charging hats 40 and all base units 60. Preferably, the attachment features and the electric mating features 7, 21 on the charging hats 40 and the base units 60 would be standardized as well. As those skilled in the art will appreciate, this standardization ensures that any given charging hat 40 can be attached to any given base unit 60. This interchangeability makes it easier to recharge the base units 60, as the user would not have to keep track of which charging hat 40 belongs to which base unit 60, as well as to replace the charging hats 40 if/when the charging hats 40 diminish in power capacity.

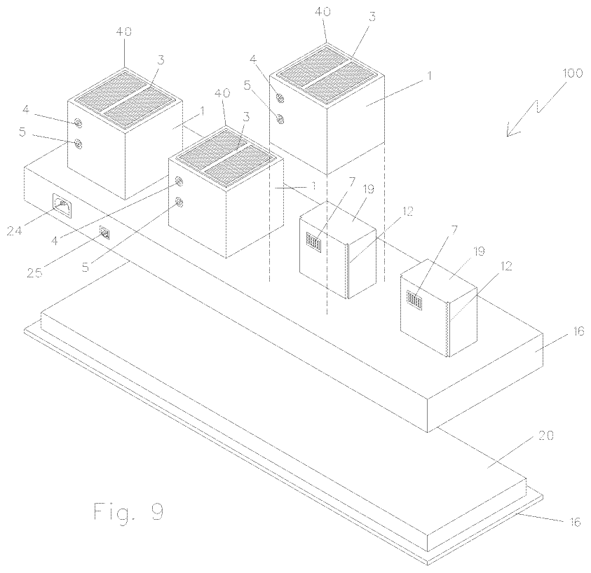

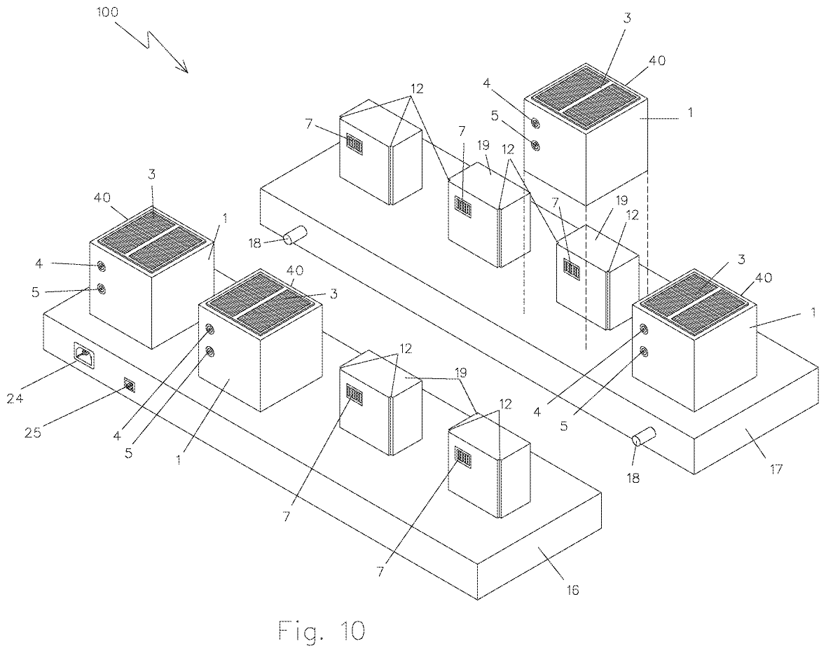

Referring to FIGS. 9 and 10, in one or more embodiments a charging bar 16 may be provided to recharge multiple charging hats 40 at once, for example, 2 to 100 at once, more favorable 4 to 20, and more favorably still 4 to 8 at once. The charging bar 16 may be particularly useful in instances where insufficient power is being generated from the photovoltaic cells 3. As shown, the charging bar 16 includes a body that houses a charging circuit 20, and disposed on top of the body are a plurality of charging base connectors 19 (four being shown). The charging base connectors 19 may be identical in size and shape to the base unit enclosures 36 shown in FIGS. 1-8, and may receive charging hats 40 in the same way. These charging base connectors 19 may also include attachment features such as alignment notches 12 and latches (not shown).

The charging circuit 20 within the charging bar 16 may be configured to transfer power to the charging hats 40 through the electric mating features 7 on the charging base connectors 19 on top of the body, and may be provided with any necessary circuitry required to do so. Further, in preferred embodiments, the charging bar 16 may also be provided with a power supply port 24 to receive power from an external power source. Additionally, the charging bars may also be provided with a data port 25 such that, for example, information about the attached charging hats 40 may be monitored simultaneously, or software updates may be transmitted to the charging hats from the charging bar (e.g., while charging).

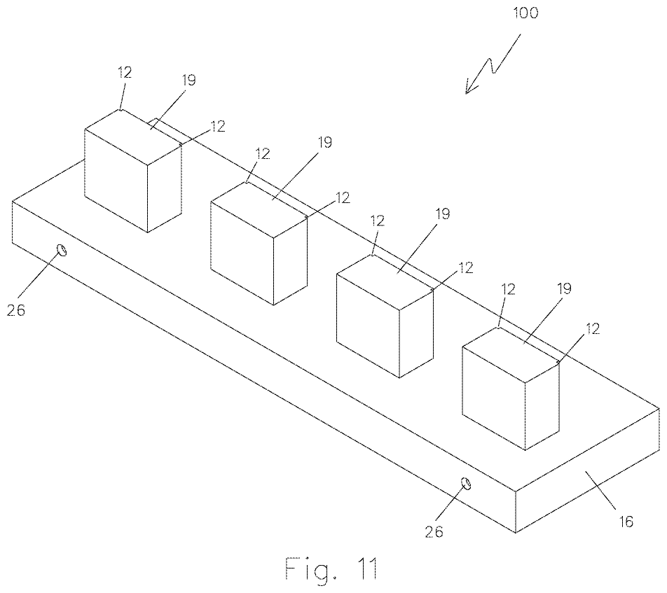

Also shown in FIG. 10 is a second charging bar 17 that may be provided to increase the charging capacity of the system 100. This second charging bar 17 may be connected to the charging bar 16 described above (i.e., a “first charging bar”) to provide additional charging base connectors 19 upon which charging hats 40 may be charged, thereby increasing the total number of charging hats 40 that may be charged simultaneously. Accordingly, the connection between the second charging bar 17 and the first charging bar 16 must be able to provide for electric power transfer, but may ideally also provide for data transfer as well. As shown, this connection may be established by way of connecting pins 18 on the second charging bar 17 that mate with (e.g., by being inserted into) connecting ports 26 provided on the first charging bar 16 (FIG. 11). Those skilled in the art will appreciate, however, that this is just one non-limiting example as other methods of establishing an electric connection may also be utilized. In any case, once connected, the charging circuit in the first charging bar 16 may supply power to a charging circuit in the second charging bar 17 (not shown), which then transfers power to electric mating features on the charging base connectors 19 on the second charging bar. Furthermore, it is also contemplated that this configuration for connecting charging bars may be continued onwards from the second charging bar to add third, fourth, and fifth charging bars, and so on.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for charging electronic devices comprising:
a charging hat comprising a control circuit electrically connected to a power cell and a first electric mating feature, and further comprising an enclosure that defines an open space, wherein the control circuit, the power cell, and the first electric mating feature are housed within the enclosure;
a base unit comprising an electronic device and a second electric mating feature electrically connected to the electronic device, wherein the second electric mating feature is configured to mate with the first electric mating feature, and the base unit is configured to be inserted into the open space of the charging hat; and
wherein the charging hat is configured to transmit electricity to the electronic device when the first electric mating feature is mated with the second electric mating feature.

2. The system of claim 1 wherein the charging hat further includes a bracket received within the first enclosure, and the control circuit and the rechargeable power cell are attached to the bracket.

3. The system of claim 2 wherein the bracket and the first enclosure define a closed space, the control circuit and the rechargeable power cell are positioned within the closed space, and wherein the closed space is a sealed environment.

4. The system of claim 1 further comprising at least one photovoltaic cell configured to recharge the power cell.

5. The system of claim 1 wherein the enclosure of the charging hat comprises a power supply port configured to connect the power cell to an external power source and to transmit electricity from the external power source to the power cell.

6. The system of claim 1 wherein the enclosure of the charging hat comprises a data port configured to connect the control circuit to a computer and to transmit information about the power cell to the computer.

7. The system of claim 1 wherein:
the base unit comprises a body comprising a bottom portion and an enclosure;
a closed space defined between the bottom portion and the enclosure; and
the electronic device is located within the closed space.

8. The system of claim 7 wherein the electronic device is an environmental sensor comprising at least one sensor pin extending through the bottom portion of the body.

9. The system of claim 1 wherein the base unit further comprises a secondary power cell electrically connected to the electronic device and the second electric mating feature.

10. The system of claim 9 wherein the base unit is configured to continuously supply power to the electronic device from the secondary power cell when the first electric mating feature is unmated from the second electric mating feature.

11. The system of claim 1 wherein the power cell of the charging hat comprises a power capacity ranging from about 2,000 milliamp hours to about 40,000 milliamp hours.

12. The system of claim 1 wherein the power cell of the charging hat comprises a voltage ranging from about 1 volt to about 50 volts.

13. The system of claim 1 wherein the power cell and the control circuit of the charging hat is configured to output a current ranging from about 1 microamp to about 10 amps.

14. A system for charging electronic devices comprising:
a plurality of charging hats, each charging hat comprising a control circuit electrically connected to a power cell and a first electric mating feature, and further comprising an enclosure that defines an open space, wherein the control circuit, the power cell, and the first electric mating feature are housed within the enclosure;
a plurality of base units, each base unit comprising an electronic device and a second electric mating feature that is electrically connected to the electronic device, wherein the second electric mating feature is configured to mate with the first electric mating feature, and each base unit is configured to be inserted into the open space of the charging hat;
wherein each charging hat is configured to transmit electricity to the electronic device of a base unit when the first electric mating feature of the charging hat is mated to the second electric mating feature of the base unit, and
wherein each charging hat further comprises a first standardized attachment feature and each base unit further comprises a second standardized attachment feature, wherein each first standardized attachment feature is configured to correspond with each second standardized attachment feature.

15. The system of claim 14 wherein:
a charging hat of the plurality of charging hats comprises key rails;
a base unit of the plurality of base units comprises alignment notches that correspond with the key rails of the charging hat; and
the key rails and the alignment notches guide the base unit into the open space of the charging hat when the base unit is being inserted into the charging hat.

16. The system of claim 14 wherein a base unit of the plurality of base units comprises a latch and a charging hat of the plurality of charging hats comprises a release button that engages the latch when the base unit is inserted into the open space of the charging hat.

17. A system for charging electronic devices comprising:
a plurality of charging hats, each charging hat comprising a control circuit electrically connected to a power cell and a first electric mating feature, and further comprising an enclosure that defines an open space, wherein the control circuit, the power cell, and the first electric mating feature are housed within the enclosure;
a plurality of base units, each base unit comprising an electronic device and a second electric mating feature that is electrically connected to the electronic device, wherein the second electric mating feature is configured to mate with the first electric mating feature, and each base unit is configured to be inserted into the open space of the charging hat;
a charging bar comprising a charging circuit and plurality of charging base connectors, wherein each charging base connecter comprises a third electric mating feature and is configured to be inserted into the open space of a charging hat, and wherein the charging circuit of the charging bar is configured to transmit electricity to each third electric mating feature; and
wherein each charging hat is configured to transmit electricity to the electronic device of a base unit when the first electric mating feature of the charging hat is mated to the second electric mating feature of the base unit; and
wherein the charging bar is configured to transmit electricity to a charging hat when the first electric mating feature of the charging hat is mated to the third electric mating feature of a charging base connector.

18. The system of claim 17 wherein:
the charging bar further comprises a connecting port; and
the system further comprises a second charging bar comprising a connecting pin that is insertable into the connecting port of the charging bar and configured to establish an electric connecting therebetween.

19. The system of claim 17 wherein the charging bar further comprises a data port that is configured to connect the charging circuit of the charging bar to a computer and, for each charging hat comprising a first electric mating feature mated to a third electric mating feature of the charging bar, the data port is further configured to transmit information about charging hat power cells to the computer.

20. The system of claim 19 wherein the charging bar is further configured to transmit software updates from the computer to a charging hat when the first electric mating feature of the charging hat is mated to a third electric mating feature of the charging bar.
